(19) United States
(12) Patent Application Publication
(10) Pub. No.: US 2017/0153587 A1
(43) Pub. Date: Jun. 1, 2017

(54) IMAGE PROCESSING APPARATUS, INFORMATION PROCESSING METHOD, AND STORAGE MEDIUM

(71) Applicant: CANON KABUSHIKI KAISHA, Tokyo (JP)

(72) Inventor: Kimito Kasahara, Tokyo (JP)

(21) Appl. No.: 15/360,897

(22) Filed: Nov. 23, 2016

(30) Foreign Application Priority Data
Dec. 1, 2015 (JP) 2015-235140

(51) Int. Cl. G03G 15/00; G03G 21/00

(52) U.S. Cl. CPC G03G 15/5016

(57) ABSTRACT

An apparatus is provided that includes an accepting unit configured to accept input of a condition of increasing a printing speed, and a control unit configured to increase the printing speed of print data in a case where the print data satisfies the condition.

### BACKGROUND OF THE INVENTION

Field of the Invention

The present invention relates to an image processing apparatus, an information processing method, and a storage medium.

Description of the Related Art

Japanese Patent Application Laid-Open No. 2005-85031 discusses an image forming apparatus that receives print data from an external apparatus and prints the print data. The image forming apparatus can change the printing speed of the image forming apparatus within a range that does not exceed the basic performance of a printing mechanism, and can change a billing charge according to the changed printing speed.

However, in a case where a plurality of users uses a single apparatus such as a multi-function peripheral installed in a working place, the users have different demands. For example, while some users are willing to pay an additional fee to promptly obtain a printed product, some other users only need to obtain a printed product at a normal speed. Accordingly, if an additional fee is charged for every printed product printed by the apparatus, unnecessary fee may be incurred.

### SUMMARY

According to an aspect of the present invention, an image processing apparatus includes an accepting unit configured to accept input of a condition of increasing a printing speed, and a control unit configured to increase the printing speed of print data in a case where the print data satisfies the condition.

Further features of the present invention will become apparent from the following description of exemplary embodiments with reference to the attached drawings.

### BRIEF DESCRIPTION OF THE DRAWINGS

FIG. 1 a diagram illustrating an example of a system configuration of an image forming system.

FIG. 2 is a block diagram illustrating an example of a hardware configuration of an information processing terminal.

FIG. 3 is a block diagram illustrating an example of a hardware configuration of an image forming apparatus.

FIG. 4 is a diagram illustrating an example of a screen for setting a condition for increasing the printing speed.

FIG. 5 is a diagram illustrating an example of a configuration of print data.

FIG. 6 is a flow chart illustrating an example of print data registration processing.

FIG. 7 is a flow chart illustrating an example of printer control processing.

### DESCRIPTION OF THE EMBODIMENTS

Various exemplary embodiments will be described in detail below with reference to the drawings.

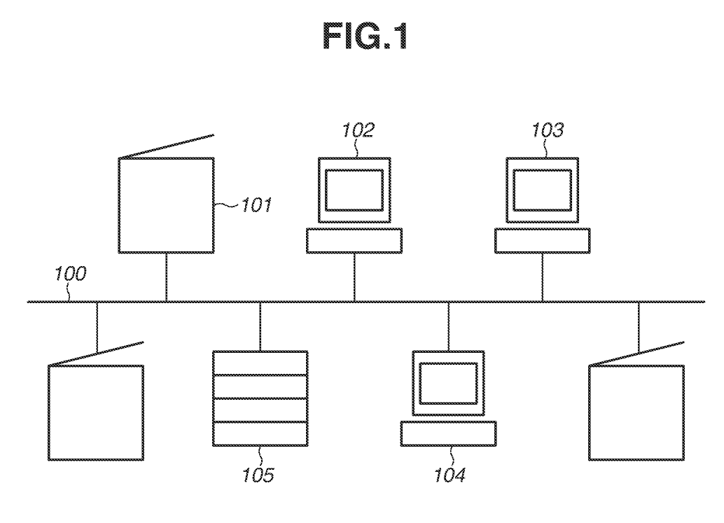

A first exemplary embodiment of the present invention will be described below. FIG. 1 illustrates an example of a system configuration of an image forming system. In the image forming system, an image forming apparatus 101, information processing terminals 102, 103, and 104, and an authentication server 105 are connected to one another via a local area network (LAN) 100. Hereinafter, the image forming apparatus 101 will be described as a representative of image forming apparatuses, and the information processing terminal 102 will be described as a representative of information processing terminals. The image forming apparatus 101 is capable of receiving print data transmitted from an external apparatus to print an image, reading an image with a scanner included in the image forming apparatus 101, and printing an image read by the scanner. The information processing terminal 102 is capable of transmitting print data to the image forming apparatus 101. The authentication server 105 is capable of managing user information and group information. The user information is information used when an apparatus in the image forming system such as the image forming apparatus 101 and the information processing terminal 102 is used. The group information is information about groups to which respective users belong.

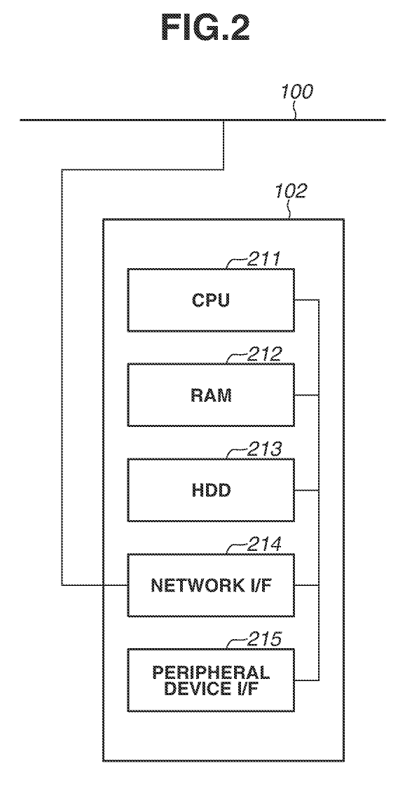

FIG. 2 illustrates an example of the hardware configuration of the information processing terminal 102.

The information processing terminal 102 includes a central processing unit (CPU) 211, a random access memory (RAM) 212, a hard disk drive (HDD) 213, a network interface (I/F) 214, and a peripheral device I/F 215.

The CPU 211 controls the entire information processing terminal 102 and is capable of controlling transmission and reception of data to and from the RAM 212, the HDD 213, the network I/F 214, and the peripheral device I/F 215. Further, the CPU 211 loads a control program (instructions) read from the HDD 213 into the RAM 212 and executes an instruction stored on the RAM 212.

A control program (instructions) for realizing processing (described below) executable by the CPU 211 is stored on the HDD 213. Besides the control program, print data, etc. to be transmitted to the image forming apparatus 101 can be stored as needed on the HDD 213.

Instructions stored on the HDD 213 can be loaded into the RAM 212 to be read by the CPU 211, and various types of data needed for execution of the instructions can be stored on the RAM 212.

The network I/F 214 is an interface for network communication with an apparatus in the image forming system. The network I/F 214 notifies the CPU 211 of reception of data via the LAN 100 and transmits data on the RAM 212 to the LAN 100.

The peripheral device I/F 215 is an interface for connecting a peripheral device such as a display and a keyboard to the information processing terminal 102. The information processing terminal 102 controls the peripheral devices connected to the peripheral device I/F 215 to present information to a user and receives an instruction from a user. The CPU 211 executes processing based on a control program stored on the HDD 213, etc. to realize a function of the information processing terminal 102.

The hardware configuration of the authentication server 105 is similar to that of the information processing terminal 102. However, data on user information and group information, instructions for accepting an authentication request from an external apparatus and returning an authentication result, etc. are stored on a HDD of the authentication server 105. A CPU of the authentication server 105 executes processing based on a control program stored on the HDD, etc. of the authentication server 105 to realize a function of the authentication server 105.

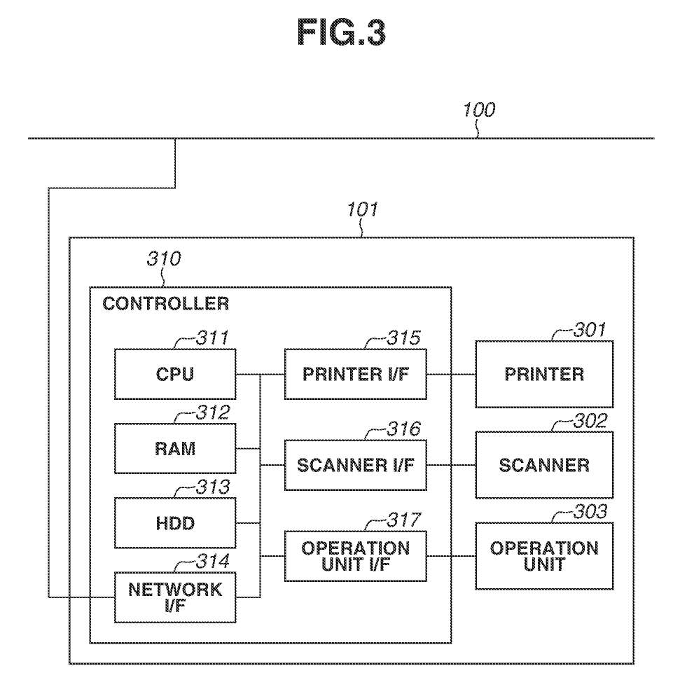

FIG. 3 illustrates an example of the hardware configuration of the image forming apparatus 101.

The image forming apparatus 101 includes a controller 310, a printer 301, a scanner 302, and an operation unit 303. The controller 310 includes a CPU 311, a RAM 312, a HDD 313, a network I/F 314, a printer I/F 315, a scanner I/F 316, and an operation unit I/F 317. The controller 310 is an example of the image forming apparatus 101. The CPU 311 can transmit and receive data to and from the RAM 312, the HDD 313, the network I/F 314, the printer I/F 315, the scanner I/F 316, and the operation unit I/F 317. The CPU 311 loads a control program (instructions) read from the HDD 313 into the RAM 312 and executes an instruction stored on the RAM 312.

The HDD 313 can store a control program (instructions) executable by the CPU 311, setting values to be used in the image forming apparatus 101, data about processing requested by a user, data received from an external apparatus, etc.

The instructions stored on the HDD 313 can be loaded into the RAM 312 to be read by the CPU 311, and various types of data needed for execution of the instruction can be stored on the RAM 312.

The network I/F 314 is an interface for network communication with an apparatus in the image forming system. The network I/F 314 notifies the CPU 311 of reception of data via the LAN 100 and transmits data on the RAM 312 to the LAN 100.

The printer I/F 315 is an interface for transmitting image data transmitted from the CPU 311 to the printer 301 and transmitting a printer status received from the printer 301 to the CPU 311.

The scanner I/F 316 is an interface for transmitting an image reading instruction transmitted from the CPU 311 to the scanner 302, transmitting image data received from the scanner 302 to the CPU 311, and transmitting information about a status received from the scanner 302 to the CPU 311.

The operation unit I/F 317 transmits a user instruction input from the operation unit 303 to the CPU 311 and transmits screen information for user operation to the operation unit 303.

The printer 301 prints image data received from the printer I/F 315 onto a sheet and transmits the printer status to the printer I/F 315. While the printer 301 performing printing through an electrophotographic process is described in the present exemplary embodiment, any other method may be used to perform printing.

The scanner 302 reads a sheet placed on the scanner 302 according to an image reading instruction received from the scanner I/F 316, converts the read image into digital data, and transmits the digital data to the scanner I/F 316. Furthermore, the scanner 302 transmits the status of the scanner 302 to the scanner I/F 316.

The operation unit 303 enables a user to operate the image forming apparatus 101. For example, the operation unit 303 includes a liquid crystal screen including a touch panel to provide an operation screen to a user and accept user operations.

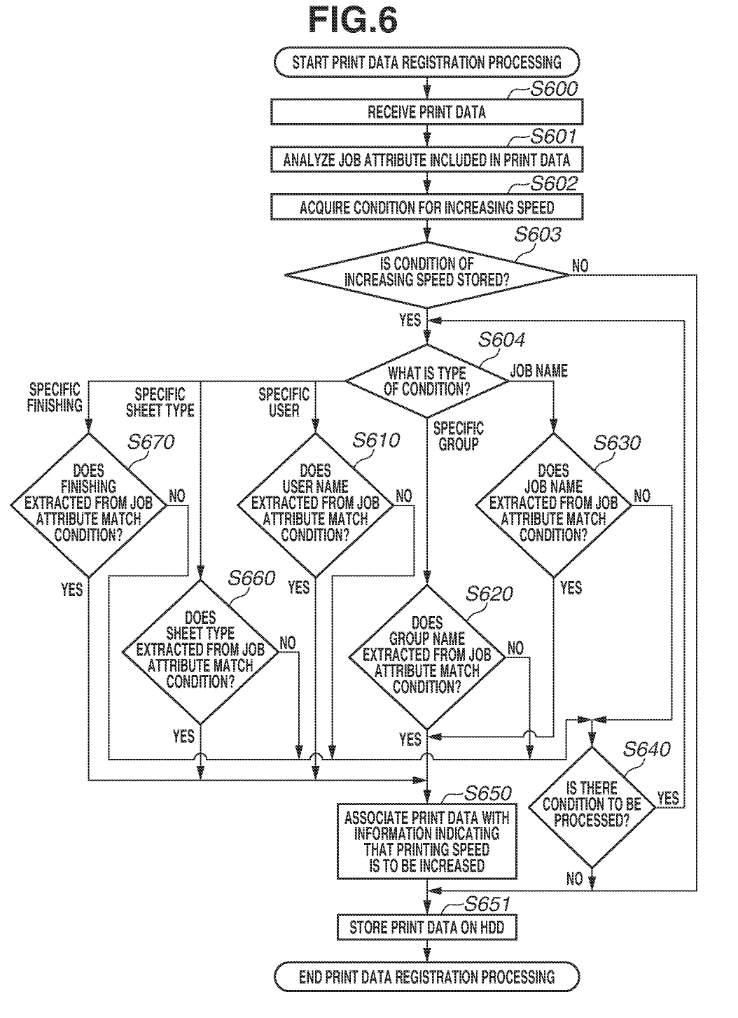

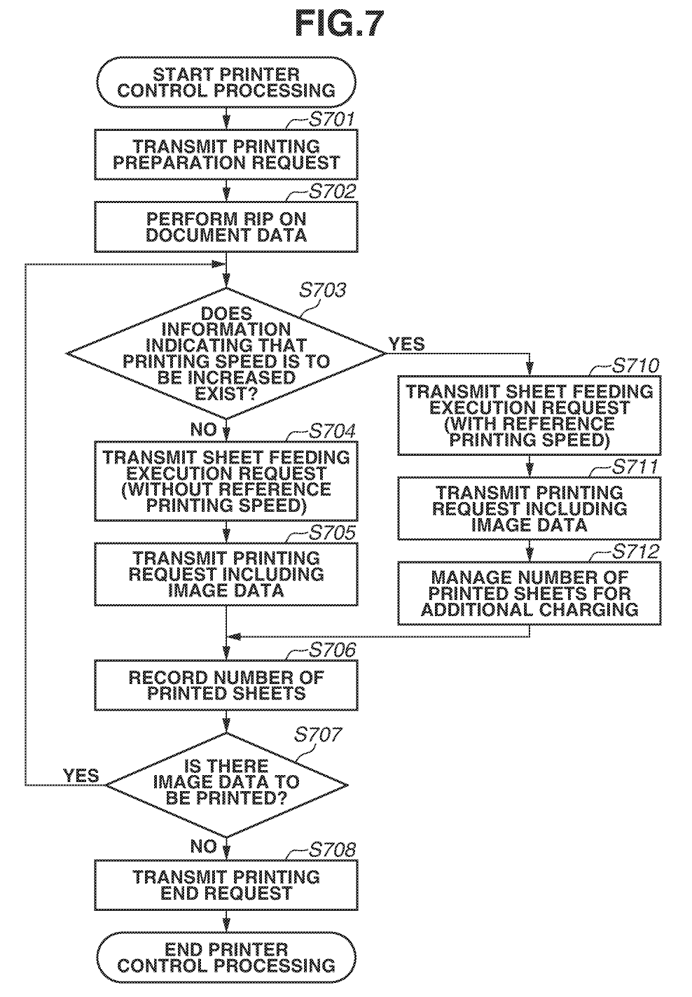

The CPU 311 executes processing based on the control program stored on the HDD 313, etc. to realize a function of the image forming apparatus 101 and processing specified in flow charts illustrated in FIGS. 6 and 7 (described below).

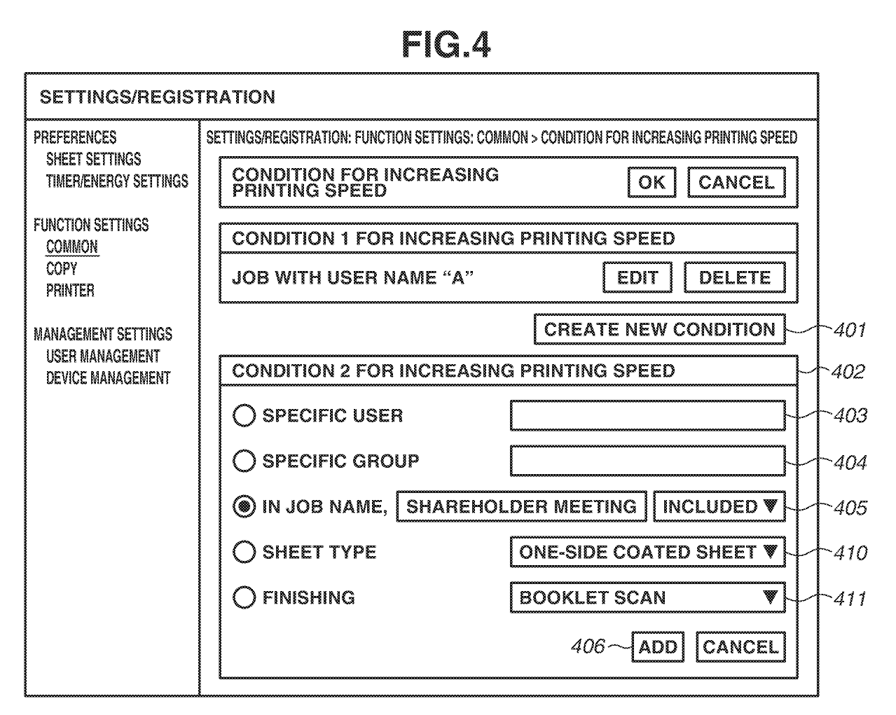

FIG. 4 illustrates an example of a screen for setting a condition of increasing the printing speed (speed increase condition) that is generated by the image forming apparatus 101.

The screen illustrated in FIG. 4 is data generated by the CPU 311 using data stored on the HDD 313 of the image forming apparatus 101. However, the CPU 311 may display the screen illustrated in FIG. 4 on the operation unit 303 according to the settings, etc. or according to a request source. Alternatively, the CPU 311 may transfer data to the information processing terminal 102 via the LAN 100, and the information processing terminal 102 may display the data on a display connected thereto.

Referring to FIG. 4, a button 401 for creating a new speed increase condition is a button that a user presses to create a new condition for the determination as to whether to increase the printing speed of print data at the time of printing the print data in a case where the CPU 311 receives the print data. In a case of printing print data that matches the created speed increase condition, the CPU 311 performs processing to increase the printing speed. On the other hand, in a case of printing print data that does not match the created speed increase condition, the CPU 311 performs printing at a normal printing speed set to the apparatus.

A setting section 402 for setting the speed increase condition indicates data, which is generated by the CPU 311 in a case where the button 401 for creating a new speed increase condition has been pressed. The user inputs details of the speed increase condition on the setting section 402. In the present exemplary embodiment, designation of a user name in a user name designation section 403 allows the CPU 311 to increase the printing speed of print data generated by the specific user. Furthermore, designation of a group name in a group name designation section 404 allows the CPU 311 to increase the printing speed of print data generated by a user belonging to the specific group. In addition, designation of a matching character string and a matching condition in a job name condition matching section 405 allows the CPU 311 to increase the printing speed of print data having a job name that matches the specific condition. Examples of the matching condition include the condition that a job name includes the matching character string, the condition that a job name starts with the matching character string, and the condition that a job name ends with the matching character string. A condition other than the foregoing conditions may be employed that designates a method for matching a matching character string with a job name. Furthermore, designation of a sheet type printable by the image forming apparatus 101 in a sheet type designation section 410 allows the CPU 311 to increase the printing speed of print data in a case where the sheet type for the print job matches the specific sheet type. Moreover, designation of finishing in a finishing designation section 411 allows the CPU 311 to increase the printing speed of print data in a case where the finishing designated for the print job is the specific finishing.

A button 406 for adding a speed increase condition is a button for storing on the image forming apparatus 101 the settings set in the setting section 402 as a condition for increasing the printing speed. When the CPU 311 has detected the press of the button 406 for adding a speed increase condition, the CPU 311 stores in a predetermined area of the HDD 313 the condition set in the setting section 402. In a case where there is a plurality of conditions, the CPU 311 stores the conditions for increasing the speed in the form of a list on the HDD 313.

While the items settable as a speed increase condition are the user name, group name, job name, sheet type, and finishing in the present exemplary embodiment, another condition may be settable. Furthermore, the CPU 311 may restrict a user and group that can operate the screen illustrated in FIG. 4 as needed. More specifically, the CPU 311 may display the screen as illustrated in FIG. 4 only in response to a request from a user or group having an administrative right. The restriction of a user and group that can operate the screen illustrated in FIG. 4 can prevent an unintended user from setting an unnecessary speed increase condition. The processing performed by the CPU 311 to display the screen illustrated in FIG. 4 is an example of screen display processing. Furthermore, the processing performed by the CPU 311 to accept a condition for increasing the printing speed, etc. via the screen illustrated in FIG. 4 is an example of accepting processing.

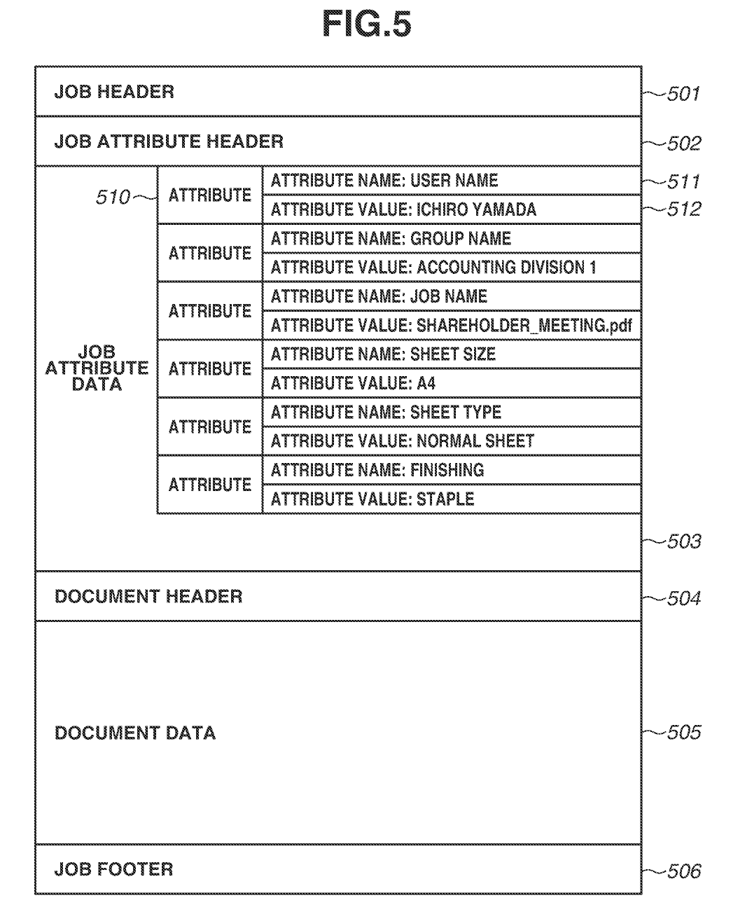

FIG. 5 illustrates an example of a configuration of print data 500 transmitted from the information processing terminal 102 to the image forming apparatus 101.

The print data 500 includes a job header 501, a job attribute header 502, job attribute data 503, a document header 504, document data 505, and a job footer 506. In the present exemplary embodiment, the term “job attribute” refers to an attribute relating to print data, and the term “document” refers to data to be printed according to an instruction received from a user.

The job header 501 includes a specific data string indicating that the data is print data, the version of the print data, the size of entire subsequent print data, and offset values of the job attribute header 502 and the document header 504.

The job attribute header 502 includes the size of subsequent job attribute data 503 and the number of attributes included in the job attribute data 503.

The job attribute data 503 includes a plurality of attributes 510, and the user name of a user having given the instruction to generate the print data, the job name associated with the print data, the time and date of generation of the print data are stored as the attributes 510. The attributes 510 each include an attribute name 511 and an attribute value 512. The attribute name 511 stores data specifying the attribute type such as “user name”, “group name”, and “job name” The attribute value 512 stores a value corresponding to an attribute name described above. While the file name of a file used to generate the print data 500 or the name of a program that generates the print data 500 is used as the job name, any other character strings may be stored. Furthermore, in the present exemplary embodiment, the job attribute data 503 further includes information about the size and type of a sheet to be used at the time of printing.

The document header 504 includes the document size and the name of the file format of the document.

The document data 505 stores data to be printed. The document to be stored may be in general file format such as Portable Document Format (PDF) or in any other file formats that can be interpreted by the image forming apparatus 101.

The job footer 506 includes a specific data sequence indicating the end of the data and a checksum value of the data.

The print data 500 illustrated in FIG. 5 is a mere example, and other data may be included as needed. Further, one or some of the components may be omitted if the image forming apparatus 101 can process print data.

FIG. 6 is a flow chart illustrating an example of print data registration processing performed by the image forming apparatus. The print data registration processing is an example of information processing. The process illustrated in FIG. 6 is started at a timing at which the CPU 311 detects reception of the print data 500 via the network I/F 314. Furthermore, the received print data 500 is stored as a print job on the HDD 313 at a time point at which the process illustrated in FIG. 6 is ended, and the print data 500 is printed through the printer 301 at another timing determined as an appropriate timing by the CPU 311. Details of printing processing will be described below.

In step S600, the CPU 311 receives the detected print data. The CPU 311 may temporarily store the received data on the RAM 312 or in a temporary storage area in the HDD 313.

Next, in step S601, the CPU 311 analyzes the print data 500 received in step S600 and extracts details of job attributes. More specifically, the CPU 311 extracts the job attribute data 503 contained in the print data 500 and loads the user name, job name, etc. into the RAM 312.

Next, in step S602, the CPU 311 reads from a predetermined area in the HDD 313 a speed increase condition that is set via the screen for setting a speed increase condition as illustrated in FIG. 4. Then, in step S603, the CPU 311 determines whether a speed increase condition is stored on the HDD 313. If the CPU 311 determines that no speed increase condition is stored on the HDD 313 (NO in step S603), the processing proceeds to step S651. In step S651, the CPU 311 stores the received print data 500 as a normal-speed print job on the HDD 313, and the process illustrated in FIG. 6 is ended.

On the other hand, if the CPU 311 determines that a speed increase condition is stored on the HDD 313 (YES in step S603), the processing proceeds to step S604. Then, the CPU 311 performs processing described below for each of the conditions for increasing the speed that are specified in the form of a list.

First, in step S604, the CPU 311 determines the type of the speed increase condition that is to be processed.

If the CPU 311 determines that a speed increase condition targeted to be processed is a condition designating a specific user (“specific user” in step S604), the processing proceeds to step S610. In step S610, the CPU 311 determines whether the user name in the print data 500 that is extracted in step S601 matches the user name designated in the speed increase condition. If the CPU 311 determines that the user names match (YES in step S610), the processing proceeds to step S650. Specifically, the CPU 311 stores on the HDD 313 the received print data 500 as a print job to be performed at an increased printing speed, and the process illustrated in FIG. 6 is ended. More specifically, in step S650, the CPU 311 associates the print data 500 with information indicating that the printing speed at the time of printing is to be increased. Then, in step S651, the CPU 311 stores in a predetermined area in the HDD 313 the print data 500 in association with the information indicating that the printing speed at the time of printing is to be increased.

On the other hand, if the CPU 311 determines that a speed increase condition targeted to be processed is a condition designating a specific group (“specific group” in step S604), the processing proceeds to step S620. In step S620, the CPU 311 determines whether the group name of the group to which the user having created the print data 500 belongs matches the group name designated in the speed increase condition. In the present exemplary embodiment, in order to determine the group to which the user having created the print data 500 belongs, the CPU 311 transmits the user name extracted in step S601 to the authentication server 105 and receives from the authentication server 105 the group name to which the user belongs. If the CPU 311 determines that the group names match (YES in step S620), the processing proceeds to step S650. The CPU 311 stores on the HDD 313 the received print data 500 as a print job to be performed at an increased printing speed, and the process illustrated in FIG. 6 is ended. More specifically, in step S650, the CPU 311 associates the print data 500 with information indicating that the printing speed at the time of printing is to be increased. Then, in step S651, the CPU 311 stores in a predetermined area in the HDD 313 the print data 500 in association with the information indicating that the printing speed at the time of printing is to be increased.

On the other hand, if the CPU 311 determines that a speed increase condition targeted to be processed designates a condition relating to a job name (“job name” in step S604), the processing proceeds to step S630. In step S630, the CPU 311 determines whether the job name extracted from the print data 500 matches the condition relating to the job name designated in the speed increase condition. For example, in a case where the condition set in the speed increase condition is that the job name “contains” the character string “shareholder meeting”, the CPU 311 determines that print data 500 having the job name “briefing document shareholder meeting.pdf” matches the condition, but determines that “FAX_order.jpg” does not match the condition. If the CPU 311 determines that the extracted job name matches the job name condition (YES in step S630), the processing proceeds to step S650. The CPU 311 stores on the HDD 313 the received print data 500 to be performed at an increased printing speed, and the process illustrated in FIG. 6 is ended. More specifically, in step S650, the CPU 311 associates the print data 500 with information indicating that the printing speed at the time of printing is to be increased. Then, in step S651, the CPU 311 stores in a predetermined area in the HDD 313 the print data 500 in association with the information indicating that the printing speed at the time of printing is to be increased.

On the other hand, if the CPU 311 determines that a speed increase condition targeted to be processed designates a condition relating to a sheet type (“specific sheet type” in step S604), the processing proceeds to step S660. In step S660, the CPU 311 determines whether the sheet type extracted from the print data 500 matches the condition relating to the sheet type designated in the speed increase condition. If the CPU 311 determines that the extracted sheet type matches the sheet type condition (YES in step S660), the processing proceeds to step S650. The CPU 311 stores on the HDD 313 the received print data 500 as a print job to be performed at an increased printing speed, and the process illustrated in FIG. 6 is ended.

More specifically, in step S650, the CPU 311 associates the print data 500 with information indicating that the printing speed at the time of printing is to be increased. Then, in step S651, the CPU 311 stores in a predetermined area in the HDD 313 the print data 500 in association with the information indicating that the printing speed at the time of printing is to be increased.

On the other hand, if the CPU 311 determines that a speed increase condition targeted to be processed designates a condition relating to finishing (“specific finishing” in step S604), the processing proceeds to step S670. In step S670, the CPU 311 determines whether the finishing extracted from the print data 500 matches the condition relating to the finishing designated in the speed increase condition. If the CPU 311 determines that the extracted finishing matches the finishing condition (YES in step S670), the processing proceeds to step S650. The CPU 311 stores on the HDD 313 the received print data 500 as a print job to be performed at an increased printing speed, and the process illustrated in FIG. 6 is ended. More specifically, in step S650, the CPU 311 associates the print data 500 with information indicating that the printing speed at the time of printing is to be increased. Then, in step S651, the CPU 311 stores in a predetermined area in the HDD 313 the print data 500 in association with the information indicating that the printing speed at the time of printing is to be increased.

In step S610, S620, S630, S660, or S670, if the CPU 311 determines that the contents of the print data 500 do not match the speed increase condition (NO in step S610, S620, S630, S660, or S670), the processing proceeds to step S640. In step S640, the CPU 311 determines whether the list still includes a speed increase condition targeted to be processed.

If the CPU 311 determines that the list still includes a speed increase condition targeted to be processed (YES in step S640), the CPU 311 returns to step S604 and performs step S604 and subsequent steps again for a next speed increase condition.

On the other hand, if the CPU 311 determines that the list no longer includes a speed increase condition targeted to be processed (NO in step S640), the processing proceeds to step S651. In step S651, the CPU 311 stores on the HDD 313 the received print data 500 as a normal-speed print job, and the process illustrated in FIG. 6 is ended.

FIG. 7 is a flow chart illustrating an example of printer control processing performed at the time of printing the print data 500 stored as a print job through the process illustrated in FIG. 6. The printer control processing is an example of information processing. The CPU 311 controls the printer 301 via the printer I/F 315 and performs printing.

The timing to start the process illustrated in FIG. 7 may be any timing determined as an appropriate timing by the CPU 311. For example, the CPU 311 starts the process illustrated in FIG. 7 when the printing of a previous print job is ended, when an instruction to start a print job is given by a user, when a sheet needed for the printing is fed, etc., but the timing to start the process is not limited thereto.

If it is determined that processing of a specific print job is started, then in step S701, the CPU 311 transmits a printing preparation request to the printer 301. In the present exemplary embodiment, the printer 301 having received a printing preparation request performs processing such as starting of a built-in fixing mechanism heating to prepare for a subsequent printing request.

Next, in step S702, the CPU 311 performs raster image processing (RIP) on the document data 505 in the print data 500 in association with the print job to be processed to generate image data corresponding to the document data 505. The CPU 311 may perform the processing while referring to other data such as the attributes 510 included in the print data 500 during the RIP processing.

Then, the CPU 311 performs the following processing for each image data generated in step S702.

In step S703, the CPU 311 determines, in printing the print data 500, whether there is information that is associated with the print data 500 and indicates that the printing speed is to be increased. The information is associated with the print data 500 in step S650 in the print data registration processing illustrated in FIG. 6.

If information indicating that the printing speed is to be increased does not exist (NO in step S703), the processing proceeds to step S704. In step S704, the CPU 311 transmits a sheet feeding execution request to the printer 301 to feed a sheet on which printing is to be performed. The sheet feeding execution request transmitted in step S704 includes the sheet size and the sheet type as parameters. The sheet size is information for designating the size of a sheet on which printing is to be performed, such as A4. The sheet type is information for designating the type of a sheet such as a normal sheet, thick sheet, or envelop. The printer 301 determines the printing speed based on the sheet size and the sheet type and physical properties of the printer 301. For example, difference in the heat transfer properties and the like may change the printing speed between the case where the sheet type is normal sheet and the case where the sheet type is thick sheet, even in a case where the sheet size is the same A4 size in both cases. In the present exemplary embodiment, the printer 301 that has received the sheet feeding execution request starts feeding a sheet and also starts controlling a relevant mechanism such as a drum in order to perform printing at a printing speed determined based on the parameters contained in the sheet feeding execution request.

In step S705, the CPU 311 transmits a printing request to the printer 301. The printing request includes at least image data to be printed. In the present exemplary embodiment, the printer 301 having received a printing request develops and fixes toner onto a sheet fed in response to the sheet feeding execution request previously received.

In step S706, the CPU 311 records the number of printed sheets to manage the number of sheets on which printing has been performed. In the present exemplary embodiment, the CPU 311 records the number of printed sheets on the HDD 313.

On the other hand, if information indicating that the printing speed is to be increased exists (YES in step S703), the CPU 311 issues a sheet feeding execution request similar to that in step S704 to the printer 301. The sheet feeding execution request issued in step S710 includes a reference printing speed in addition to the sheet size and the sheet type, which are described above in the description of step S704. The reference printing speed is information for giving an instruction to the printer 301 using a printing speed under a specific printing condition as a reference speed. The reference printing speed is an example of speed information. Furthermore, the sheet feeding execution request is an example of a printing execution request. As an example of the printing condition used for the reference printing speed, a description is given of a case where the sheet size is A4 and the sheet type is normal sheet. In the present exemplary embodiment, the CPU 311 sets the printing speed for an A4 normal sheet to 30 ppm (page per minute) in the case where the CPU 311 transmits the sheet feeding execution request in step S704. On the other hand, the CPU 311 sets the reference printing speed to 50 ppm in the case where the CPU 311 transmits the sheet feeding execution request in step S710. As in step S704, the printer 301 determines, using the reference printing speed as a reference, the actual printing speed based on the sheet size, sheet type, basic printing speed, and the physical properties of the printer 301. For example, in a case where the sheet feeding execution request specifying the sheet size of A4, the sheet type of normal sheet, and the reference printing speed of 50 ppm is issued, since the sheet size and sheet type conditions are the same as the conditions of the reference printing speed, actual printing is performed at 50 ppm. In a case where the sheet feeding execution request specifying the sheet size of A4, the sheet type of thick sheet, and the reference printing speed of 50 ppm is issued, based on the assumption that it takes a longer time to form an image on a thick sheet than on a normal sheet, which is a reference condition, as the properties of the printer 301, the printing speed may be, for example, 40 ppm. Accordingly, even in a case where the actual printing speed varies depending on the sheet size and sheet type, using the concept of the reference printing speed can control increase of the printing speed relative to the printing speed set at the time of the shipment of the apparatus. In the present exemplary embodiment, when the sheet feeding execution request has been received, the printer 301 starts feeding a sheet and also starts controlling a relative mechanism such as a drum to perform printing at a printing speed determined based on the parameters included in the sheet feeding execution request.

In step S711, the CPU 311 transmits the printing request to the printer 301. The processing performed in step S711 is similar to the processing performed in step S705.

In step S712, the CPU 311 manages the number of printed sheets of the print job performed at the increased printing speed, i.e., the number of printed sheets for additional charging, separately from the record of the number of printed sheets described above in the description of step S706. In the present exemplary embodiment, the CPU 311 records in a predetermined area in the HDD 313 the number of printed sheets of the print job performed at the increased printing speed. More specifically, each time a print job is printed at an increased printing speed, the CPU 311 counts up the number of printed sheets of the print job performed at the increased printing speed, which number is recorded in the predetermined area in the HDD 313 (or increments the value indicating the number of printed sheets). An area for recording the number of printed sheets for a job performed at an increased printing speed is prepared separately so that additional charge based on pay-per-use can be made separately for the job performed at the increased printing speed. For example, when the CPU 311 has detected a predetermined input via the operation unit 303, the CPU 311 calculates an amount of fee relating to the charge based on the number of printed sheets that is recorded on the HDD 313, and displays the calculated amount on the operation unit 303. Further, the CPU 311 calculates an amount of fee relating to the pay-per-use basis charge based on the number of printed sheets of the job performed at the increased printing speed, which number is recorded in the predetermined area in the HDD 313, and displays the calculated amount on the operation unit 303. In this way, a service engineer who performs maintenance and the like periodically, e.g., at the end of each month, can perform a predetermined operation to check an amount of fee relating to the number of printed sheets of normal jobs and jobs performed at an increased printing speed, and can charge the users. Further, the CPU 311 may be configured to accept a transmission request for an amount of fee relating to the charge from an external server, etc. via the network I/F 314, etc. When the CPU 311 has received the transmission request for an amount of fee relating to the charge, the CPU 311 calculates the amount of fee relating to the charge based on the number of printed sheets that is recorded on the HDD 313. In addition, the CPU 311 calculates an amount of fee relating to the pay-per-use basis charge based on the number of printed sheets of jobs performed at an increased printing speed that is recorded in the predetermined area in the HDD 313. Then, the CPU 311 may transmit a response including the respective calculated amounts of fees to the server, etc. having transmitted the transmission request via the network I/F 314, etc. In this way, the server, etc. can charge the user and collect the fee through withdrawal of the money from an account of the user, etc. based on the amount of fee relating to the number of printed sheets of normal jobs and the number of printed sheets of jobs performed at an increased printing speed.

After the processing in step S712, the CPU 311 performs the processing in step S706 as in the case where the printing speed is not to be increased.

In step S707 following step S706, the CPU 311 determines whether there is image data to be printed.

If the CPU 311 determines that there remains image data to be printed (YES in step S707), the CPU 311 repeats step S703 and subsequent steps for next image data. On the other hand, if the CPU 311 determines that there is no more image data to be printed (NO in step S707), the processing proceeds to step S708. In step S708, the CPU 311 transmits a printing end request to the printer 301, and the process illustrated in FIG. 7 is ended. In the present exemplary embodiment, the printer 301 having received the printing end request performs post-processing including stop of the fixing mechanism heating and stop of the rotation of the drum.

The foregoing describes that the printing control and charging control can be performed by which the image forming apparatus accepts the setting of the condition for increasing the speed at the time of printing, collates the contents of print data with the set condition for increasing the speed at the reception of the print data, and increases the printing speed if the contents match the set condition. In this way, the printing speed can be increased only when the increase is needed in a case where the image forming apparatus is shared by a plurality of users.

While the exemplary embodiments have been described in detail, the present invention is not limited to a specific exemplary embodiment described above. For example, the hardware configuration of the image forming apparatus 101 is not limited to the configuration illustrated in FIG. 3, and the image forming apparatus 101 may include a plurality of CPUs, a plurality of network interfaces, a plurality of operation unit interfaces, and a plurality of operation units.

The information processing according to an exemplary embodiment described above can increase the printing speed, etc. in an environment in which an apparatus is shared by a plurality of users in a case where a specific condition is satisfied.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-235140, filed Dec. 1, 2015, which is hereby incorporated by reference herein in its entirety.

What is claimed is:

1. An image processing apparatus comprising:
an accepting unit configured to accept input of a condition of increasing a printing speed; and
a control unit configured to increase the printing speed of print data in a case where the print data satisfies the condition.

2. The image processing apparatus according to claim 1, further comprising a determining unit configured to determine whether the print data satisfies the condition,
wherein in a case where the determining unit determines that the print data satisfies the condition, the printing speed of the print data is increased.

3. The image processing apparatus according to claim 1, further comprising a screen displaying unit configured to display a screen for accepting the input of the condition,
wherein the accepting unit accepts the input of the condition via the screen displayed by the screen displaying unit.

4. The image processing apparatus according to claim 1, wherein in a case where the print data satisfies the condition, the control unit increases the printing speed of the print data by transmitting to a printer a printing execution request including speed information.

5. The image processing apparatus according to claim 1, further comprising a charging control unit configured to count up the number of printed sheets for additional charging in a case where the printing speed of the print data is increased by the control unit.

6. The image processing apparatus according to claim 5, wherein the charging control unit calculates a fee amount for additional charging based on the number of printed sheets for additional charging and displays the fee amount on an operation unit.

7. The image processing apparatus according to claim 5, wherein the charging control unit calculates a fee amount for additional charging based on the number of printed sheets for additional charging and transmits the fee amount to an external apparatus connected via a network.

8. The image processing apparatus according to claim 1,
wherein the accepting unit accepts as the condition a condition relating to a user having generated the print data, and
wherein in a case where the print data satisfies the condition relating to the user, the control unit increases the printing speed of the print data.

9. The image processing apparatus according to claim 1,
wherein the accepting unit accepts as the condition a condition relating to a group to which a user having generated the print data belongs, and
wherein in a case where the print data satisfies the condition relating to the group, the control unit increases the printing speed of the print data.

10. The image processing apparatus according to claim 1,
wherein the accepting unit accepts as the condition a condition relating to a name of the print data, and
wherein in a case where the print data satisfies the condition relating to the name, the control unit increases the printing speed of the print data.

11. The image processing apparatus according to claim 1,
wherein the accepting unit accepts as the condition a condition relating to a type of a sheet to be used to print the print data, and
wherein in a case where the print data satisfies the condition relating to the type of the sheet, the control unit increases the printing speed of the print data.

12. The image processing apparatus according to claim 1,
wherein the accepting unit accepts as the condition a condition relating to finishing to be performed at a time of printing the print data, and
wherein in a case where the print data satisfies the condition relating to the finishing, the control unit increases the printing speed of the print data.

13. An information processing method to be executed by an image processing apparatus, the method comprising:
accepting input of a condition of increasing a printing speed; and
performing control to increase the printing speed of print data in a case where the print data satisfies the condition.

14. A storage medium storing a program that causes a computer to execute a method comprising:
accepting input of a condition of increasing a printing speed; and
performing control to increase the printing speed of print data in a case where the print data satisfies the condition.
